(19) United States
(12) Patent Application Publication
(10) Pub. No.: US 2024/0187177 A1
(43) Pub. Date: Jun. 6, 2024

(54) SSB and PRACH Transmissions During Initial Access in Wireless Communications

(71) Applicant: Apple Inc., Cupertino, CA (US)

(72) Inventors: Hong HE, San Jose, CA (US); Chunhai YAO, Beijing (CN); Chunxuan YE, San Diego, CA (US); Dawei ZHANG, Saratoga, CA (US); Haitong SUN, Cupertino, CA (US); Jie CUI, San Jose, CA (US); Oghenekome OTERI, San Diego, CA (US); Wei ZENG, Saratoga, CA (US); Weidong YANG, San Diego, CA (US); Yushu ZHANG, Beijing (CN)

(21) Appl. No.: 17/759,686

(22) PCT Filed: Aug. 5, 2021
(86) PCT No.: PCT/CN2021/111035

§ 371 Date: Jul. 28, 2022

(51) Int. Cl. H04L 5/00; H04W 74/00

(52) U.S. Cl. CPC H04L 5/0051; H04L 5/0053; H04W 74/006

(57) ABSTRACT

A user equipment (UE) is configured to receive a synchronization signal block (SSB) transmission with a first subcarrier spacing (SCS) in an SSB burst window (SSBW), decode the SSB transmission to determine parameters for a control resource set 0 (CORESET #0) to be transmitted in the SSBW using a second SCS that is different from the first SCS, monitor physical downlink control channel (PDCCH) candidates in the determined CORESET #0 based on a mapping between the SSB transmission and the CORESET #0 and decode the PDCCH and a system information block 1 (SIB1) scheduled by the PDCCH in the SSBW.

### TECHNICAL FIELD

This application relates generally to wireless communication systems, and in particular relates to SSB and PRACH transmissions during initial access in wireless communications.

### BACKGROUND INFORMATION

A user equipment (UE) may establish a connection to at least one of a plurality of different networks or types of networks. In some networks, signaling between the UE and a base station of a network may occur over the millimeter wave (mmWave) spectrum (30-300 GHz). Signaling over the mmWave spectrum may be achieved by beamforming, which is an antenna technique used to transmit or receive a directional signal.

5G New Radio (NR) operation may be extended from the up to 52 GHz frequency range to 71 GHz. In some operations, such as initial access procedures, it may be desired to transmit certain signals, e.g., a system synchronization block (SSB), with a numerology (subcarrier spacing (SCS)) different from other signals, e.g., a ControlResourceSet0 (CORESET #0) and a system information block 1 (SIB1). For example, the SCS used for CORESET #0/SIB1 transmission may be 480 kHz or 960 kHz, while the SCS used for SSB may be 120 kHz. Various operations for initial access may be affected when using a mixed and/or increased numerology.

### SUMMARY

Some exemplary embodiments are related to a processor of a user equipment (UE) configured to perform operations. The operations include receiving a synchronization signal block (SSB) transmission with a first subcarrier spacing (SCS) in an SSB burst window (SSBW), decoding the SSB transmission to determine parameters for a control resource set 0 (CORESET #0) to be transmitted in the SSBW using a second SCS that is different from the first SCS, monitoring physical downlink control channel (PDCCH) candidates in the determined CORESET #0 based on a mapping between the SSB transmission and the CORESET #0 and decoding the PDCCH and a system information block 1 (SIB1) scheduled by the PDCCH in the SSBW.

Other exemplary embodiments are related to a processor of a base station configured to perform operations. The operations include transmitting a synchronization signal block (SSB) transmission with a first subcarrier spacing (SCS) in an SSB burst window (SSBW), wherein a user equipment (UE) decodes the SSB transmission to determine parameters for a control resource set 0 (CORESET #0) to be transmitted in the SSBW using a second SCS that is different from the first SCS and transmitting a physical downlink control channel (PDCCH) in the CORESET #0 associated with the transmitted SSB and a system information block 1 (SIB1) with the second SCS using the resources scheduled by the transmitted PDCCH, wherein the UE monitors the PDCCH in the CORESET #0 based on an association between the SSB and the CORESET #0 and decodes the PDCCH and the SIB1 scheduled by the PDCCH in the SSBW.

Still further exemplary embodiments are related to a processor of a user equipment (UE) configured to perform operations. The operations include selecting a physical random access channel (PRACH) occasion to transmit a random access preamble, receiving a downlink control information (DCI) with a cyclic redundancy check (CRC) scrambled by a random access radio network temporary identifier (RA-RNTI), receiving, in the DCI, an indication of a segment index for the RA-RNTI, the segment index corresponding to a segment of a PRACH transmission window associated with the DCI that is used to schedule a random access response (RAR) physical downlink shared channel (PDSCH) reception, receiving the PDSCH transmission and decoding the RAR PDSCH reception if the PRACH occasion selected by the UE is associated with the decoded RA-RNTI and the segment index in the DCI that scheduled the RAR PDSCH.

Additional exemplary embodiments are related to a processor of a user equipment (UE) configured to perform operations. The operations include receiving a random access response (RAR) transmission with a first numerology μ_1 in a physical random access channel (PRACH) transmission window and decoding the RAR transmission by calculating a random access radio network temporary identifier (RA-RNTI) based on the first numerology μ_1 and a second numerology μ_2, wherein the second numerology μ_2 is a reference numerology.

More exemplary embodiments are related to a processor of a base station configured to perform operations. The operations include receiving from a user equipment (UE) a random access preamble in a physical random access channel (PRACH) occasion, determining a segment index for the received preamble based on a time location within a PRACH transmission window, determining a random access radio network temporary identifier (RA-RNTI) value for the received preamble based on the time location and a frequency location of the received PRACH, transmitting a downlink control information (DCI) to the UE wherein the DCI includes a field to indicate the determined segment index and a cyclic redundancy check (CRC) of the DCI is scrambled by the determined RA-RNTI value, transmitting to the UE a random access response (RAR) transmission that is scheduled by the DCI, wherein the UE decodes the RAR transmission by calculating the RA-RNTI and the segment index indicated in the DCI.

Further exemplary embodiments are related to a processor of a user equipment (UE) configured to perform operations. The operations include transmitting to a user equipment (UE) a random access response (RAR) transmission wherein a cyclic redundancy check (CRC) of the RAR is scrambled by a random access radio network temporary identifier (RA-RNTI) calculated based on a first numerology μ_1 of a physical random access channel (PRACH) transmission and a second numerology μ_2, wherein the second numerology μ_2 is a reference numerology.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary network cell according to various exemplary embodiments.

FIG. 4 shows an exemplary SSB burst window (SSBW) with a mixed numerology multiplexing pattern according to various exemplary embodiments described herein.

FIG. 5 shows an exemplary SSB burst window (SSBW) with a mixed numerology multiplexing pattern and a pairing between SSB and CORESET0/RMSI slots according to various exemplary embodiments described herein.

FIG. 6 shows an exemplary PRACH transmission window in which the slots are divided into N segments according to various exemplary embodiments described herein.

FIG. 7 shows exemplary slot diagrams for a modified RA-RNTI calculation according to various exemplary embodiments described herein.

### DETAILED DESCRIPTION

The exemplary embodiments may be further understood with reference to the following description and the related appended drawings, wherein like elements are provided with the same reference numerals. The exemplary embodiments relate to operations to support an increased subcarrier spacing (SCS) used for transmission of initial access signals, specifically control resource set 0 (CORESET #0) and system information block 1 (SIB1), which may be referred to herein as remaining minimum system information (RMSI). In one embodiment, a multiplexing pattern is described in which a mixed numerology is used for transmissions of the system synchronization block (SSB) and CORESET #0/RMSI, wherein the CORESET #0/RMSI is transmitted with an SCS of 480 kHz or 960 kHz. In another embodiment, modifications are made to the existing radio access (RA) radio network temporary identifier (RNTI) (RA-RNTI) determination in view of the increased SCS (480 kHz, 960 kHz) used for physical random access channel (PRACH) transmissions.

The exemplary embodiments are described with regard to operations performed by a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

The exemplary embodiments are also described with regard to a 5G New Radio (NR) network. However, reference to a 5G NR network is merely provided for illustrative purposes. The exemplary embodiments may be utilized with any network that utilizes beamforming. Therefore, the 5G NR network as described herein may represent any type of network that implements beamforming.

### Network/Devices

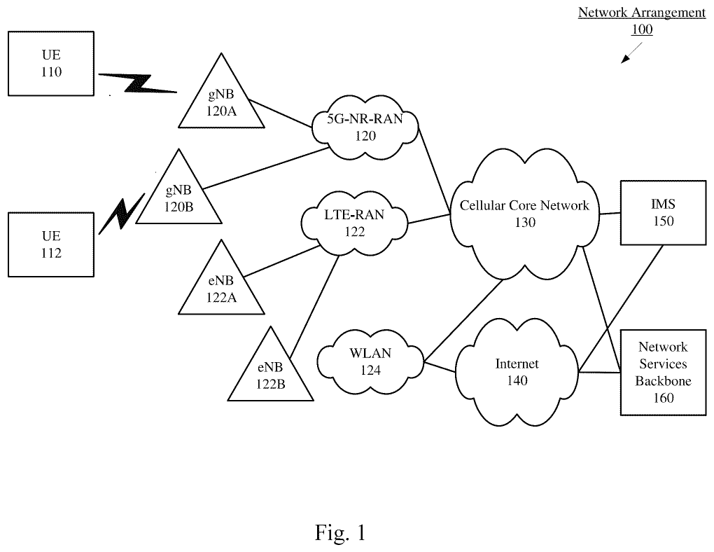

FIG. 1 shows an exemplary network arrangement 100 according to various exemplary embodiments. The exemplary network arrangement 100 includes a plurality of UEs 110, 112. Those skilled in the art will understand that the UEs may be any type of electronic component that is configured to communicate via a network, e.g., a component of a connected car, a mobile phone, a tablet computer, a smartphone, a phablet, an embedded device, a wearable, an Internet of Things (IOT) device, etc. It should also be understood that an actual network arrangement may include any number of UEs being used by any number of users. Thus, the example of two UEs 110, 112 is merely provided for illustrative purposes. In some of the exemplary embodiments described below, groups of UEs may be employed to conduct respective channel measurements.

The UEs 110, 112 may communicate directly with one or more networks. In the example of the network configuration 100, the networks with which the UEs 110, 112 may wirelessly communicate are a 5G NR radio access network (5G NR-RAN) 120, an LTE radio access network (LTE-RAN) 122 and a wireless local access network (WLAN) 124. Therefore, the UEs 110, 112 may include a 5G NR chipset to communicate with the 5G NR-RAN 120, an LTE chipset to communicate with the LTE-RAN 122 and an ISM chipset to communicate with the WLAN 124. However, the UEs 110, 112 may also communicate with other types of networks (e.g., legacy cellular networks) and the UE 110 may also communicate with networks over a wired connection. With regard to the exemplary embodiments, the UEs 110, 112 may establish a connection with the 5G NR-RAN 120.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UEs 110, 112 may connect to the 5G NR-RAN 120 via at least one of the next generation nodeB (gNB) 120A and/or the gNB 120B. Reference to two gNBs 120A, 120B is merely for illustrative purposes. The exemplary embodiments may apply to any appropriate number of gNBs. For example, the UEs 110, 112 may simultaneously connect to and exchange data with a plurality of gNBs in a multi-cell CA configuration. The UEs 110, 112 may also connect to the LTE-RAN 122 via either or both of the eNBs 122A, 122B, or to any other type of RAN, as mentioned above. In the network arrangement 100, the UE 110 is shown as having a connection to the gNB 120A, while the UE 112 is shown as having a connection to gNB 120B.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network, e.g., the 5GC for NR. The cellular core network 130 also manages the traffic that flows between the cellular network and the Internet 140.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

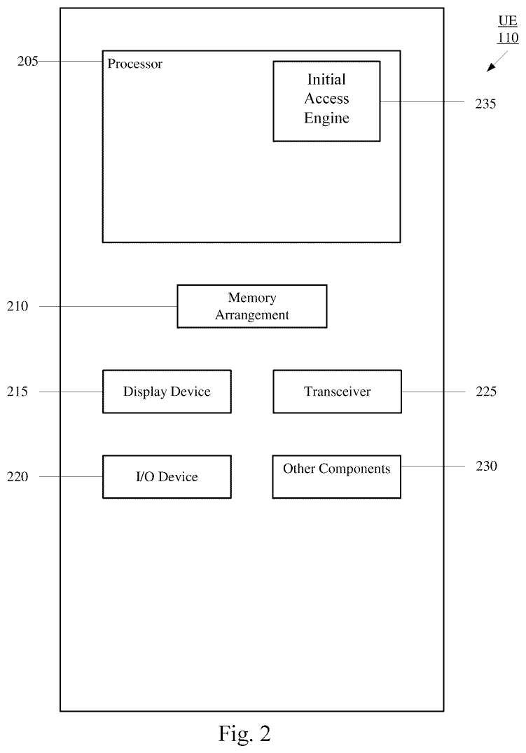

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc. The UE 110 illustrated in FIG. 2 may also represent the UE 112.

The processor 205 may be configured to execute a plurality of engines for the UE 110. For example, the engines may include an initial access engine 235 for performing operations for initial access including decoding an SSB and, based on an association between the SSB and a subsequently received CORESET #0/RMSI, decoding the RMSI. As will be described in further detail below, the SSB and the CORESET #0/RMSI may be transmitted in a same SSB burst window (SSBW) using a multiplexing pattern comprising different SCSs for the SSB and the CORESET #0/RMSI. The initial access engine 235 may perform further operations including exchanging signaling with the network a random access procedure in which a modified RA-RNTI design is used for decoding a random access response (RAR) from the network, to be described in further detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies). For example, the transceiver 225 may operate on the unlicensed spectrum when e.g., NR-U is configured.

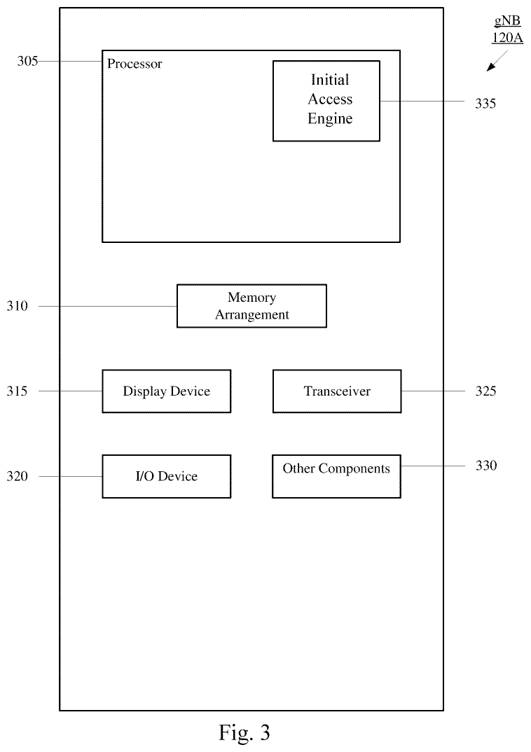

FIG. 3 shows an exemplary network cell, in this case gNB 120A, according to various exemplary embodiments. As noted above with regard to the UE 110, the gNB 120A may represent a cell providing services as a PCell or an SCell, or in a standalone configuration with the UE 110. The gNB 120A may represent any access node of the 5G NR network through which the UEs 110, 112 may establish a connection and manage network operations. The gNB 120A illustrated in FIG. 3 may also represent the gNB 120B.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include an initial access engine 335 for performing operations for initial access including broadcasting an SSB and a CORESET #0/RMSI for decoding by the UE so that the UE can initiate a random access procedure with the network. As will be described in further detail below, the SSB and the CORESET #0/RMSI may be transmitted in a same SSB burst window (SSBW) using a multiplexing pattern comprising different SCSs for the SSB and the CORESET #0/RMSI. The initial access engine 335 may perform further operations for a random access procedure in which a modified RA-RNTI design is used for scrambling the cyclic redundancy check (CRC) of the PDCCH for CORESET #0 with a radio access (RA) radio network temporary identifier (RNTI) (RA-RNTI) for scheduling the transmission of a PDSCH that carries a random access response (RAR), wherein the UE uses the RA-RNTI to decode the PDCCH, to be described in further detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UEs 110, 112 and any other UE in the system 100. The transceiver 325 may operate on a variety of different frequencies or channels (e.g., set of consecutive frequencies). For example, the transceiver 325 may operate on unlicensed bandwidths when NR-U functionality is configured. Therefore, the transceiver 325 may include one or more components (e.g., radios) to enable the data exchange with the various networks and UEs.

### Initial Access in NR

The 5G NR initial access procedure generally comprises the following operations. However, it should be understood that the exemplary embodiments are not limited to any particular access procedure or order of the operations. The following is provided as an example to illustrate a use case for the exemplary embodiments to support an increased SCS for transmission of initial access signals.

First, a gNB periodically broadcasts system information (SI), which may be categorized as minimum system information (MSI) and other system information (OSI), using beam sweeping. Beam sweeping generally refers to the transmission of a plurality of transmitter beams over a particular spatial area during a predetermined duration. Each beam transmitted during a transmitter beam sweep may include a reference signal. A UE may measure one or more of the transmitter beams based on their respective reference signals and select one of the transmitter beams based on the measurement data.

A synchronization signal block (SSB) broadcast by the gNB comprises synchronization signals (SS) (a primary synchronization signal (PSS) and a secondary synchronization signal (SSS)) and a physical broadcast channel (PBCH), wherein the PBCH transmission includes a master information block (MIB) containing MSI. The MSI includes parameters indicating the location and resources for ControlResourceSet0 (CORESET #0) on the resource grid, which carries the downlink control information (DCI) used to decode system information block 1 (SIB1). SIB1 may be referred to as remaining minimum system information (RMSI), a subset of MSI, and is carried on the PDSCH. The SSB (including the MIB) and the CORESET #0/RMSI (SIB1) are transmitted on a same beam, which, when selected by the UE, will be used by the UE for random access channel (RACH) transmissions until a dedicated connection is established and the beam is switched. OSI includes SIB2 to SIB9, which may be broadcast or provisioned for the UE via dedicated RRC signaling.

The parameter PDCCH Config SIB1, transmitted in the MIB, has a length of 8 bits, with the first 4 bits (most significant bits (MSB)) determining the “controlResourceSetZero” index, which indicates the number of resource blocks/symbols used to determine the CORESET #0 of the type0 PDCCH Common Search Space. The last 4 bits (least significant bits (LSB)) determine the “searchSpaceZero” Index, which indicates the PDCCH Monitoring Occasions.

Next, the UE performs the beam measurements, detects the best SSB (e.g., the strongest beam) and selects this beam. The UE then decodes the SSB and, based on the extracted MSI parameters, searches the Type0-PDCCH common search space (CSS) for downlink control information (DCI) on the CORESET #0, which is then used to decode SIB1. The extracted SI allows the UE to use the same beam to initiate the random access (RACH procedure) by transmitting Msg1 of the RACH procedure, i.e., the RACH preamble, on the physical random access channel (PRACH).

The gNB responds to the detected RACH preamble (Msg1) with a random access response (RAR) (Msg2) on the PDSCH. The PDCCH transmission scheduling the PDSCH includes a scheduling grant indicating the PUSCH resource for an RRC connection request (Msg3). The UE transmits Msg3 on the scheduled PUSCH, and the gNB responds with an RRC connection setup (Msg4). The UE subsequently provides a beam/CSI report to complete the RACH procedure, and a dedicated connection is established between the UE and the gNB. After the dedicated connection is established, the UE and the gNB may switch to a different beam.

Returning to the RAR (Msg2), the medium access layer (MAC) of the gNB generates the RAR and maps the RAR to the PDSCH. The gNB scrambles the cyclic redundancy check (CRC) of the PDCCH with a radio access (RA) radio network temporary identifier (RNTI) (RA-RNTI) for transmission of PDSCH that carries RAR (s). The UE in turn uses the RA-RNTI to decode the PDCCH.

The RA-RNTI is a function of the time and frequency of the PRACH occasion (i.e., RACH occasion (RO)) the RACH preamble is detected on, according to the following equation:

RA-RNTI=1+s_{id}+14×t_{id}+14×80×f_{id}+14×80×8×ul_carrier_{id},

where s_id is an index of the first OFDM symbol of the specified PRACH (0≤s_id<14), t_id is an index of the first slot of the specified PRACH in a system frame (0≤t_id<80), f_id is an index of the specified PRACH in the frequency domain (0≤f_id<8), and ul_carrier_id is a value for the uplink carrier used for Msg1 transmission (0 for normal UL (NUL) carrier, and 1 for supplementary UL (SUL) carrier).

### Initial Access in NR Operations Up to 71 GHz

NR operation may be extended from the currently specified 52 GHz frequency range up to 71 GHz, where operations in the extended frequency range (52-71 GHz) may include both licensed and unlicensed operations. The following objectives relate to initial access procedures in the extended frequency range: support of up to 64 synchronization signal block (SSB) beams for licensed and unlicensed operation in this frequency range; support for a 120 kHz subcarrier spacing (SCS) for SSB and a 120 kHz SCS for initial access related signals/channels in an initial bandwidth part (BWP); specification of additional SCS (240 kHz, 480 kHz, 960 kHz) for SSB, and additional SCS (480 kHz, 960 kHz) for initial access related signals/channels in an initial BWP; and specification of additional SCS (480 kHz, 960 kHz) for SSB for cases other than initial access.

A first issue related to initial access procedures in the extended frequency range is how to support a mixed numerology μ for SSB and CORESET #0 transmission on the same beam, for example an SSB transmitted using μ=3 (120 kHz SCS) and a CORESET #0/RMSI transmission using μ=5, 6 (480 kHz or 960 kHz SCS) to achieve single numerology operation.

A second issue related to initial access procedures in the extended frequency range is how to determine the RA-RNTI in view of the increased SCS. Increasing the SCS to 480/960 KHz for >52.6 GHz or higher may cause RA-RNTI shortage problems. As discussed above, the RA-RNTI equation includes a variable t_id for a slot index. As the SCS increases, the slot length becomes shorter, which increases the number of slots in a frame. The increased number of slots necessitates an increased range for the index values, which, when used in the existing RA-RNTI equation, may cause the calculated RA-RNTI to exceed the 16-bit width used in current systems.

According to certain aspects of the present disclosure, the following multiplexing pattern in the time domain may be used to transmit CORESET #0/RMSI with a larger SCS e.g., 480 kHz/960 kHz in slots that are not used for SSB transmission with a smaller SCS, e.g., 120 kHz SCS.

The design of the multiplexing pattern is motivated to reduce the latency of the RMSI acquisition by using larger SCSs having a short slot duration, which makes it possible to fit RMSI transmissions into the gaps between SSB-bursts. This design allows operators to use a single higher numerology, e.g., 960 kHz SCS for all channels (CORESETs including CORESET #0, RMSI over PDSCH, CSI-RS and unicast PDCCH/PDSCH) except the SSB, which may reduce network complexity and improve resource efficiency.

It is noted that in the following description, the numerology μ represents a subcarrier spacing as follows: μ=0 represents a 15 kHz SCS, μ=1 represents a 30 kHz SCS, μ=2 represents a 60 kHz SCS, μ=3 represents a 120 kHz SCS, μ=4 represents a 240 kHz SCS, μ=5 represents a 480 kHz SCS, and μ=6 represents a 960 kHz SCS. The slot length for a transmission changes based on the numerology. For example, for μ=0, the slot length is 1 ms; for μ=1, the slot length is 0.5 ms; for μ=2, the slot length is 0.25 ms; for μ=3, the slot length is 0.125 ms; for μ=4, the slot length is 0.0625 ms; for μ=5, the slot length is 0.03125 ms; for μ=6, the slot length is 0.015625 ms.

SSBs are transmitted in four OFDM symbols across 240 subcarriers in the frequency domain and in pre-defined bursts across the time domain on configured PRBs. The burst periodicity with respect to time depends on which numerology μ is configured.

The following terms may be defined to facilitate the description of the multiplexing pattern: an “SSB slot” refers to a slot with a first SCS pi (e.g. μ1=3) having two SSB transmissions; a CORESET0/RMSI slot refers to a slot with a second SCS μ₂ (e.g. μ2=5, 6) reserved for CORESET #0/RMSI transmission (s) that is one-to-one associated with the SSB transmitted in the SSB slots within a same SSB Burst Window (SSBW); and the SSBW window refers to a window having a first ‘M’ consecutive SSB slots with the first SCS μ1 and subsequent ‘N’ consecutive slots with the second SCS μ2.

The values of <M, N> pairs may be hard-encoded in specification for different combinations of <μ1, μ2>. For example, for mixed numerology <μ1, μ2>=<3, 5> the <M, N> values are <4, 4>. In another example, for mixed numerology <μ1, μ2>=<3, 6>, the <M, N> values are <4, 8>. The <M, N> values are dependent on the SCS or slot length based on the SCS.

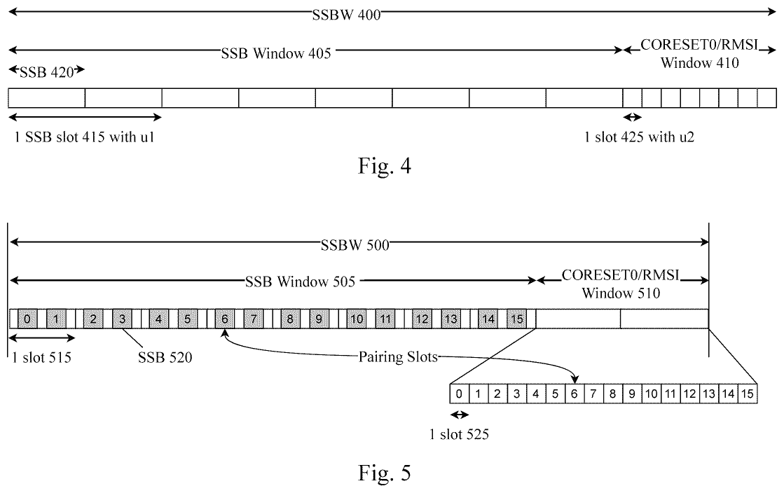

FIG. 4 shows an exemplary SSB burst window (SSBW) 400 with a mixed numerology multiplexing pattern according to various exemplary embodiments described herein. In the exemplary SSBW 400, the mixed numerology <μ1, μ2>=<3, 5>. The SSBW 400 includes an SSB window 405 and a CORESET0/RMSI window 410. As discussed above, the <M, N> values for this mixed numerology are <4, 4>. Thus, the SSB window 405 comprises four SSB slots 415 with an SCS of 120 kHz, wherein each SSB slot 415 includes two SSBs 420. The CORESET0/RMSI window 410 comprises eight CORESET0/RMSI slots 425.

The reception of the PBCH, PSS and SSS are in consecutive symbols and form an SS/PBCH block. In the time domain, the first symbol is PSS, the second symbol is PBCH, the third symbol is SSS and the fourth symbol is PBCH. The first symbol index for a candidate SSB is determined based on the SCS of the SSB, wherein index 0 corresponds to the first symbol of the first slot in a half-frame.

For SSB with μ1=3 (120 kHz SCS), the first symbols of the candidate SS/PBCH blocks have indexes {4, 8, 16, 20}+28*n, where n=0, 1, 3, 5, 6, 7, 8, 10, 11, 12, 13, 15, 16, 17, 18. The association between the CORESET0/RMSI transmission and the SSB (which carries the information necessary to receive the DCI for the CORESET and decode the RMSI) within a SSBW may be defined as follows.

For CORESET0/RMSI with μ2=5 (480 kHz SCS) and μ2=6 (960 kHz SCS), the UE monitors PDCCH in the Type0-PDCCH CSS set in the slot that is associated with SSB with index i, as follows: n₀=[i*M], where M=½ for μ2=5 and M=1 for μ2=6. The slots of CORESET0/RMSI using SCS μ2 are indexed every SSB Burst Window starting from n0=0. Denoting the first symbol index of Type0-PDCCH CSS set for SSB index i as ‘kᵢ’, if M=½, kᵢ=0 if i is even. Otherwise, kᵢ=7 if i is odd. If M=1, kᵢ=0.

Thus, according to the above description, for mixed numerology <3, 5>, the M-to-N mapping between the M SSB slots and the corresponding N CORESET #0 slots includes indexing the SSB slots with the first SCS in the SSBW from 0 to {M−1} and indexing the CORESET #0 slots with the second SCS in the SSBW from 0 to {N−1}. The indexes are reset every SSBW period. The SSB index ‘i’ that is transmitted with the first SCS in a SSB slot index [i/2] is associated with the CORESET #0 and the SIB1 transmitted with the second SCS in a CORESET #0 slot index [i/2] with a first symbol index ‘k’ based on a value of the associated SSB index ‘i’. The first symbol index ‘k’ of the CORESET #0 associated with the SSB index ‘i’ is 0 when the SSB index ‘i’ is even, or k=7 when the SSB index ‘i’ is odd.

For mixed numerology <3, 6>, the M-to-N mapping between the M SSB slots and the corresponding N CORESET #0 slots includes indexing the SSB slots with the first SCS in the SSBW from 0 to {M−1} and indexing the CORESET #0 slots with the second SCS in the SSBW from 0 to {N−1}. The indexes are reset every SSBW period. The SSB index ‘i’ that is transmitted with the first SCS in a SSB slot index [i/2] is associated with the CORESET #0 and the SIB1 transmitted with the second SCS in a CORESET #0 slot index ‘i’. The first symbol index of the CORESET #0 in the CORESET #0 slot ‘i’ with the second SCS is 0.

FIG. 5 shows an exemplary SSB burst window (SSBW) 500 with a mixed numerology multiplexing pattern and a pairing between SSB and CORESET0/RMSI slots according to various exemplary embodiments described herein. In the example of FIG. 5, the SSB has numerology μ1=3 (120 kHz SCS) and the CORESET0/RMSI has numerology μ2=6 (960 kHz SCS). As discussed above, for mixed numerology <μ1, μ2>=<3, 6>, the <M, N> values are <4, 16>. Similar to SSBW 400 of FIG. 4, the SSBW 500 includes an SSB window 505 and a CORESET0/RMSI window 510. The SSB window 505 comprises eight SSB slots 515 with an SCS of 120 kHz, wherein each SSB slot 515 includes two SSBs 520. The 16 SSB are indexed from 0 to 15. The CORESET0/RMSI window 510 comprises 16 CORESET0/RMSI slots 525, which are similarly indexed from 0 to 15. As shown in FIG. 5, the SSB with index i are paired with the CORESET0/RMSI slot having the same index i.

For example, in accordance with the association details discussed above, the UE monitors PDCCH in the Type0-PDCCH CSS set associated with SSB index #6 in CORESET0/RMSI slot with index #6 (e.g., n₀=[6*1]), and monitors PDCCH in the Type0-PDCCH CSS set associated with SSB index #15 in CORESET0/RMSI slot with index #15. As can be seen from this description, the latency is reduced because the CORESET0 information is in the same SSBW, e.g., the UE does not have to wait for subsequent SSBWs to determine the CORESET0 associated with an SSB as would need to be done if the SSB and CORESET0 SCS were the same.

To provide a contrast to the above example, in the example of FIG. 4, the UE monitors PDCCH in the Type0-PDCCH CSS set associated with SSB index #6 in CORESET0/RMSI slot with index #3 (e.g., n₀=[6*½]). It should be seen that this is because the slots for μ2=6 are one half the length of the slots for μ2=5.

According to other exemplary embodiments, various solutions may be considered to determine the RA-RNTI values to address the out of range problem discussed above, wherein the number of slots in a frame carrying transmissions with an SCS of 480 kHz or 960 kHz would cause an increase in the slot index range, such that the calculated RA-RNTI may exceed the existing 16-bit field.

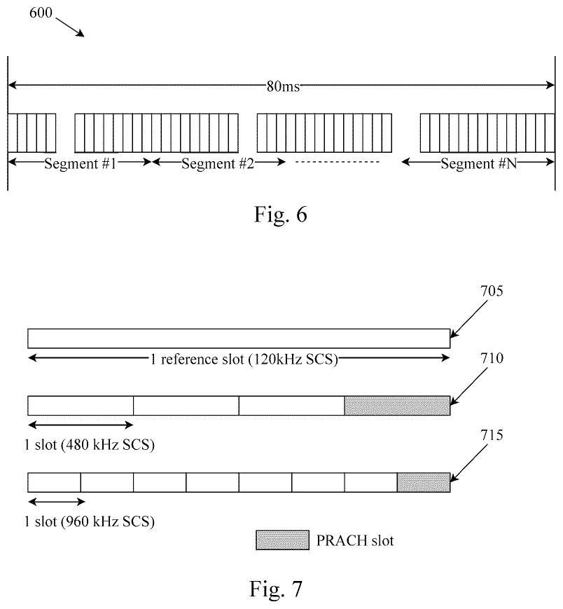

According to one option, the slots in a PRACH transmission window may be divided into sub-groups or segments and the existing equation for calculating RA-RNTI may be used in unmodified form. The 80 ms PRACH transmission window may be first divided into ‘N’ slot sub-groups with each sub-group consisting of ‘M’ slots e.g., M=640. FIG. 6 shows an exemplary PRACH transmission window 600 in which the slots are divided into N segments, wherein each segment in the PRACH window 600 comprises M slots.

With a maximum of M slots, the existing RA-RNTI equation will not exceed the 16-bit field. To know which segment is used, the segment index of the corresponding RACH occasion (RO) may be signaled to the UE by the DCI format 1_0 that schedules the RAR transmission. The number of segments (N value) may be dependent on the SCS for the RAR transmission. For example, for an SCS of 480 kHz, N=4 and for an SCS of 960 kHz, N=8.

Different approaches may be considered to signal the segment index to the UE via the DCI that schedules the RAR transmission. In one alternative, a new field may be introduced by repurposing some reserved bits (e.g., 2 or 3 bits) from reserved bits (e.g., 16 bits), or the least significant bits (LSBs) of the subframe number (SFN) IE may be newly introduced for DCI Format 1_0 with CRC scrambled by RA-RNTI.

In a second alternative, the segment index may be divided into two parts, e.g., Part 1 and Part 2. Part 1 may be included in the payload of DCI Format 1_0 with CRC scrambled by RA-RNTI, while Part 2 may be conveyed based on the scrambling sequence selected to scramble the CRC bits of DCI Format 1_0 as shown in Table 1 below. As shown, the selected scrambling sequence can indicate Part 2 of the segment index.

TABLE 1 [symbol]
selection for segment index indication

| Segment index [symbol] | [symbol] |
|---|---|
| 00 | [symbol] |
| 01 | [symbol] |
| 10 | [symbol] |
| 11 | [symbol] |

[symbol]

indicates data missing or illegible when filed

Thus, to implement the above approach with respect to the first variant, the following procedure may be used. First, the UE selects a physical random access channel (PRACH) occasion to transmit a random access preamble. The network determines a segment index for the received preamble based on a time location within a PRACH transmission window and determines a random access radio network temporary identifier (RA-RNTI) value for the received preamble based on the time location and a frequency location of the received PRACH. The network transmits a downlink control information (DCI) to the UE, wherein the DCI includes a field to indicate the determined segment index, and a cyclic redundancy check (CRC) of the DCI is scrambled by the determined RA-RNTI value. The UE receives the DCI, including the indication of the segment index, receives the PDSCH transmission, and decodes the RAR PDSCH reception if the PRACH occasion selected by the UE is associated with the decoded RA-RNTI and the segment index in the DCI that scheduled the RAR PDSCH.

The indication of the segment index is received in a single field in the DCI scheduling the RAR transmission, wherein the single field in the DCI indicating the segment index is defined by repurposing two or three bits in the ‘reserved’ field of an existing DCI format. Alternatively, the indication of the segment index is divided in two parts, wherein a first part of the segment index is transmitted in a field of the DCI scheduling the RAR transmission and a second part of the segment index is indicated by selecting an associated scrambling sequence to scramble the CRC bits of the DCI. The association between the scrambling sequence and a value of the second part of the segment index is hard-encoded in specification. The second part of the segment index may be 2-bits, and the association between the scrambling sequence and the value of the second part of the segment index comprises the following: segment index ‘00’ is associated with scrambling sequence ‘0000 . . . 00’; segment index ‘01’ is associated with scrambling sequence ‘1111 . . . 11’; segment index ‘10’ is associated with scrambling sequence ‘1010 . . . 10’; and segment index ‘11’ is associated with scrambling sequence ‘0101 . . . 01’.

According to a second variant, the existing equation for calculating RA-RNTI is used with the following modification. In this option, the parameter t_id is determined based on a slot index with reference SCS μ_{ref}. In some designs, μ_{ref}=3 (120 kHz SCS) for both 480 kHz and 960 KHz SCS. Alternatively, the existing equation can be modified to include the term a as follows:

RA-RNTI=1+s_{id}+14×t_{id}×α+14×80×f_{id}+14×80×8×ul_carrier_{id}, where α=2^{(μref-u)}.

Thus, the value for the α term may be α=0.25 for μ=5 or α=0.125 for μ=6. It is noted that the second variant works only on the condition that there is only one RO for the new 480/960 kHz SCS within a reference slot e.g., 120 kHz SCS.

FIG. 7 shows exemplary slot diagrams for a modified RA-RNTI calculation according to various exemplary embodiments described herein. The slot diagram 405 shows a RACH occasion (RO) with a 120 kHz SCS which may be used as a reference slot. The slot diagram 410 shows an RO with a 480 kHz SCS, wherein the UE may calculate the RA-RNTI based on the index of slot 405 with 120 kHz SCS. The slot diagram 415 shows an RO with a 960 kHz SCS, wherein the UE may calculate the RA-RNTI based on the index of slot 405 with 120 kHz SCS. With this approach, the RA-RNTI can be ensured to be within the 16-bits range and therefore RA-RNTI overflow issue can be mitigated.

Thus, to implement the above approach with respect to the second variant, the following procedure may be used. First, the network transmits to a user equipment (UE) a random access response (RAR) transmission wherein a cyclic redundancy check (CRC) of the RAR is scrambled by a random access radio network temporary identifier (RA-RNTI) calculated based on a first numerology μ_1 of a physical random access channel (PRACH) transmission and a second reference numerology μ_2. The reference numerology μ_2 may be 3, and the first numerology μ_1 of the PRACH transmission may be 5 or 6. Calculating the RA-RNTI based on the first numerology μ_1 and the reference numerology μ_2 may include determining a scaling factor α=2^{μ}^{₂}^{-μ}^{₁} and using the scaling factor to scale a slot index value used in an RA-RNTI computation equation.

### Examples

In a first example, a processor of a user equipment (UE) is configured to perform operations comprising receiving a random access response (RAR) transmission with a first numerology μ_1 in a physical random access channel (PRACH) transmission window and decoding the RAR transmission by calculating a random access radio network temporary identifier (RA-RNTI) based on the first numerology μ_1 and a second numerology μ_2, wherein the second numerology μ_2 is a reference numerology.

In a second example, the processor of the first example, wherein the first numerology of the PRACH transmission window is 5 and the reference numerology μ_2 for RA-RNTI calculation is 3.

In a third example, the processor of the first example, wherein the first numerology of the PRACH transmission window is 6 and the reference numerology μ_2 for RA-RNTI calculation is 3.

In a fourth example, the processor of the first example, wherein calculating the RA-RNTI based on the first numerology μ_1 and the reference numerology μ_2 comprises determining a scaling factor α=2^{μ}^{₂}^{-μ}^{₁} and using the scaling factor to scale a slot index value used in an RA-RNTI computation equation.

In a fifth example, a processor of a base station is configured to perform operations comprising transmitting to a user equipment (UE) a random access response (RAR) transmission wherein a cyclic redundancy check (CRC) of the RAR is scrambled by a random access radio network temporary identifier (RA-RNTI) calculated based on a first numerology μ_1 of a physical random access channel (PRACH) transmission and a second numerology μ_2, wherein the second numerology μ_2 is a reference numerology.

In a sixth example, the processor of the fifth example, wherein the first numerology μ_1 of the PRACH transmission window is 5 and the reference numerology μ_2 for RA-RNTI calculation is 3.

In a seventh example, the processor of the fifth example, wherein the first numerology μ_1 of the PRACH transmission window is 6 and the reference numerology μ_2 for RA-RNTI calculation is 3.

In an eighth example, the processor of the fifth example, wherein calculating the RA-RNTI based on the first numerology μ_1 and the reference numerology μ_2 comprises determining a scaling factor α=2^{μ}^{₂}^{-μ}^{₁} and using the scaling factor to scale a slot index value used in an RA-RNTI computation equation.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1-28. (canceled)

29. A processor of a user equipment (UE) configured to perform operations comprising:
receiving a random access response (RAR) transmission with a first numerology μ_1 in a physical random access channel (PRACH) transmission window;
decoding the RAR transmission by calculating a random access radio network temporary identifier (RA-RNTI) based on the first numerology μ_1 and a second numerology μ_2, wherein the second numerology μ_2 is a reference numerology.

30. The processor of claim 29, wherein the first numerology μ_1 of the PRACH transmission window is 5 and the reference numerology μ_2 for RA-RNTI calculation is 3.

31. The processor of claim 29, wherein the first numerology μ_1 of the PRACH transmission window is 6 and the reference numerology μ_2 for RA-RNTI calculation is 3.

32. The processor of claim 29, wherein calculating the RA-RNTI based on the first numerology μ_1 and the reference numerology μ_2 comprises determining a scaling factor α=2^{μ}^{₂}^{-μ}^{₁} and using the scaling factor to scale a slot index value used in an RA-RNTI computation equation.

33. The processor of claim 32, wherein the slot index value corresponds to a first symbol of the PRACH transmission window.

34. The processor of claim 29, wherein a subcarrier spacing (SCS) comprises one of 120 kHz, 480 kHz or 960 kHz.

35. The processor of claim 29, wherein calculating the RA-RNTI is further based on a frequency index of the PRACH transmission window.

36. A user equipment (UE), comprising:
a transceiver configured to communicate with a base station; and
a processor communicatively coupled to the transceiver and configured to perform operations comprising:
receiving a random access response (RAR) transmission with a first numerology μ_1 in a physical random access channel (PRACH) transmission window;
decoding the RAR transmission by calculating a random access radio network temporary identifier (RA-RNTI) based on the first numerology μ_1 and a second numerology μ_2, wherein the second numerology μ_2 is a reference numerology.

37. The UE of claim 36, wherein the first numerology μ_1 of the PRACH transmission window is 5 and the reference numerology μ_2 for RA-RNTI calculation is 3.

38. The UE of claim 36, wherein the first numerology μ_1 of the PRACH transmission window is 6 and the reference numerology μ_2 for RA-RNTI calculation is 3.

39. The UE of claim 36, wherein calculating the RA-RNTI based on the first numerology μ_1 and the reference numerology μ_2 comprises determining a scaling factor α=2^{μ}^{₂}^{-μ}^{₁} and using the scaling factor to scale a slot index value used in an RA-RNTI computation equation.

40. The UE of claim 39, wherein the slot index value corresponds to a first symbol of the PRACH transmission window.

41. The UE of claim 36, wherein a subcarrier spacing (SCS) comprises one of 120 kHz, 480 kHz or 960 kHz.

42. The UE of claim 36, wherein calculating the RA-RNTI is further based on a frequency index of the PRACH transmission window.

43. A processor of a base station configured to perform operations comprising:
determining a random access response (RAR) transmission, wherein a cyclic redundancy check (CRC) of the RAR is scrambled by a random access radio network temporary identifier (RA-RNTI) calculated based on a first numerology μ_1 of a physical random access channel (PRACH) transmission and a second numerology μ_2, wherein the second numerology μ_2 is a reference numerology; and
transmitting the RAR to a user equipment (UE).

44. The processor of claim 43, wherein the first numerology μ_1 of the PRACH transmission window is 5 and the reference numerology μ_2 for RA-RNTI calculation is 3.

45. The processor of claim 43, wherein the first numerology μ_1 of the PRACH transmission window is 6 and the reference numerology μ_2 for RA-RNTI calculation is 3.

46. The processor of claim 43, wherein calculating the RA-RNTI based on the first numerology μ_1 and the reference numerology μ_2 comprises determining a scaling factor α=2^{μ}^{₂}^{-μ}^{₁} and using the scaling factor to scale a slot index value used in an RA-RNTI computation equation.

47. The processor of claim 46, wherein the slot index value corresponds to a first symbol of the PRACH transmission window.

48. The processor of claim 43, wherein a subcarrier spacing (SCS) comprises one of 120 kHz, 480 kHz or 960 kHz.
